(19) United States
(12) Patent Application Publication
(10) Pub. No.: US 2007/0024994 A1
(43) Pub. Date: Feb. 1, 2007

(54) Structured optical film with interspersed pyramidal structures

(75) Inventors: Leland R. Whitney, St. Paul, MN (US); Byung-Soo Ko, Seoul (KR); Mark E. Gardiner, Petaluma, CA (US); Dongwon Chae, Suwon City (KR)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/193,052

(22) Filed: Jul. 29, 2005

(51) Int. Cl. G02B 5/30

(52) U.S. Cl. 359/831

(57) ABSTRACT

Optical films are disclosed that include a substantially transparent body having a first surface defined by a substrate portion and a structured surface disposed over the substrate portion opposite to the first surface. The structured surface includes a plurality of smaller pyramidal structures and a plurality of larger pyramidal structures interspersed with the plurality of smaller pyramidal structures. Each pyramidal structure has a base including at least two first sides disposed opposite to each other and at least two second sides disposed opposite to each other. Also disclosed are optical devices including such optical films.

### FIELD OF THE INVENTION

The present disclosure is directed to structured optical films and optical devices incorporating such optical films.

### BACKGROUND

Display devices, such as liquid crystal display (“LCD”) devices, are used in a variety of applications including, for example, televisions, hand-held devices, digital still cameras, video cameras, and computer monitors. An LCD offers several advantages over a traditional cathode ray tube (“CRT”) display such as decreased weight, unit size and power consumption. However, an LCD panel is not self-illuminating and, therefore, sometimes requires a backlighting assembly or a “backlight.” A backlight typically couples light from one or more sources (e.g., a cold cathode fluorescent tube (“CCFT”) or light emitting diode (“LED”)) to a substantially planar output, for example, via a lightguide. The substantially planar output is then coupled to the LCD panel.

The performance of an LCD is often judged by its brightness. Brightness of an LCD may be enhanced by using a larger number of light sources or brighter light sources. However, additional light sources and/or a brighter light source may consume more energy, which is counter to the ability to decrease the power allocation to the display device. For portable devices this may correlate to decreased battery life. Also, adding a light source to the display device may increase the product cost and weight and sometimes can lead to reduced reliability of the display device.

Brightness of an LCD device may also be enhanced by more efficiently utilizing the light that is available within the LCD device (e.g., to direct more of the available light within the display device along a preferred viewing axis). For example, Vikuiti™ Brightness Enhancement Film (“BEF”), available from 3M Company, has prismatic surface structures, which redirect some of the light exiting the backlight outside the viewing range to be substantially along the viewing axis. At least some of the remaining light is recycled via multiple reflections of some of the light between BEF and reflective components of the backlight, such as its back reflector. This results in optical gain substantially along the viewing axis and also results in improved spatial uniformity of the illumination of the LCD. Thus, BEF is advantageous, for example, because it enhances brightness and improves spatial uniformity. For a battery powered portable device, this may translate to longer running times or smaller battery size, and a display that provides a better viewing experience.

### SUMMARY

In one aspect, the present disclosure is directed to optical films including a substantially transparent body having a first surface defined by a substrate portion and a structured surface disposed over the substrate portion opposite to the first surface. The structured surface includes a plurality of smaller pyramidal structures and a plurality of larger pyramidal structures interspersed with the plurality of smaller pyramidal structures. Each pyramidal structure having a base including at least two first sides disposed opposite to each other and at least two second sides disposed opposite to each other. Such optical films may be incorporated into optical devices including a light source and disposed such that the structured surface faces away from the light source.

In another aspect, the present disclosure is directed to optical films including a substantially transparent body having a first surface defined by a substrate portion and a structured surface disposed over the substrate portion opposite to the first surface. The structured surface includes a plurality of smaller pyramidal structures and a plurality of larger pyramidal structures interspersed with the plurality of smaller pyramidal structures. Each pyramidal structure having a base including at least two first sides disposed opposite to each other and at least two second sides disposed opposite to each other. In this exemplary implementation, the plurality of the larger pyramidal structures, the first sides are longer than the second sides. Such optical films also may be incorporated into optical devices including a light source and disposed such that the structured surface faces away from the light source.

In yet another aspect, the present disclosure is directed to optical films including a substantially transparent body having a first surface defined by a substrate portion and a structured surface disposed over the substrate portion opposite to the first surface. The structured surface includes a plurality of pyramidal structures, each pyramidal structure having a peak and a base. The peaks are defined by a first pair of facets and the bases include at least two first sides disposed opposite to each other defined by a second pair of facets and at least two second sides disposed opposite to each other. The first pair of prism facets has a first included angle and the second pair of prism facets has a second included angle, and the first included angle is different than the second included angle. Such optical films also may be incorporated into optical devices including a light source and disposed such that the structured surface faces away from the light source.

These and other aspects of the optical films and optical devices of the subject invention will become more readily apparent to those having ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, wherein:

FIG. 1A shows schematically a planar lightguide edge-lit backlight;

FIG. 1B shows schematically a wedge lightguide edge-lit backlight;

FIG. 1C shows schematically a backlight utilizing an extended light source;

FIG. 1D shows schematically a direct-lit backlight;

FIG. 2 shows schematically a cross-sectional view of a prior art optical film;

FIG. 3A is a schematic partial perspective view of an exemplary optical film constructed according to the present disclosure;

FIG. 3B is a partial cross-sectional view of the exemplary optical film shown in FIG. 3A in the XY plane;

FIG. 3C is another partial cross-sectional view of the exemplary optical film shown in FIG. 3A in the XY plane;

FIG. 4A shows schematically a top view of an individual pyramidal structure of an exemplary optical film according to the present disclosure;

FIG. 4B shows schematically a cross-sectional view of the pyramidal structure illustrated in FIG. 4A in the YZ plane;

FIG. 4C shows schematically another cross-sectional view of the pyramidal structure illustrated in FIG. 4A in the YX plane;

FIG. 5A shows schematically a cross-sectional view of a pyramidal structure of an exemplary optical film according to the present disclosure, positioned over a backlight;

FIG. 5B shows schematically another cross-sectional view of the pyramidal structure illustrated in FIG. 5A;

FIG. 6 is a schematic cross-sectional view of an exemplary optical film constructed according to the present disclosure in an optical device;

FIG. 7A is an iso-candela polar plot for an exemplary optical film as shown in FIG. 3A; and

FIG. 7B contains rectangular distribution plots, representing cross-sections of the data shown in FIG. 7A taken at 0, 45, 90 and 135 degree angles.

### DETAILED DESCRIPTION

The present disclosure is directed to structured optical films capable of controlling angular distribution of light and optical devices incorporating such optical films. In particular, the optical films according to the present disclosure may be capable of controlling angular output distribution of light from a backlight, such as an LCD backlight.

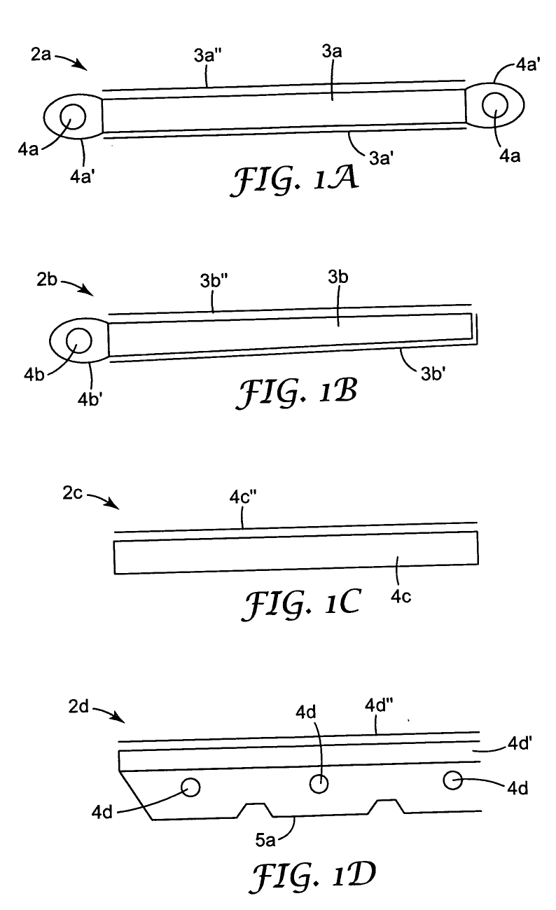

FIGS. 1A-1D show several examples of optical devices, such as backlights, that may be used with LCD panels or other light-gating devices and that may benefit from the structured optical films according to the present disclosure. FIG. 1A shows a backlight 2a including a lightguide 3a, illustrated as a substantially planar lightguide, light sources 4a disposed on one, two or more sides of the lightguide 3a, such as one or more CCFTs or one or more LEDs, lamp reflectors 4a′ disposed about the light sources 4a, a back reflector 3a′ and one or more optical films 3a″, which may be any suitable optical films. FIG. 1B shows a backlight 2b including a lightguide 3b, illustrated as a wedge-shaped lightguide, a light source 4b disposed on one side of the lightguide 3b, such as one or more CCFTs or one or more LEDs, a lamp reflector 4b′ disposed about the light source 4b, a back reflector 3b′ and one or more optical films 3b″, which may be any suitable optical films. FIG. 1C shows a backlight 2c including an extended light source 4c, such as a surface emission-type light source, and one or more optical films 4c″ disposed over the extended light source 4c. FIG. 1D shows schematically a partial view of a direct-lit backlight 2d including three or more light sources 4d, such as CCFTs or LEDs, a back reflector 5a, a diffuser plate 4d′ and one or more optical films 4d″, which may be any suitable optical films.

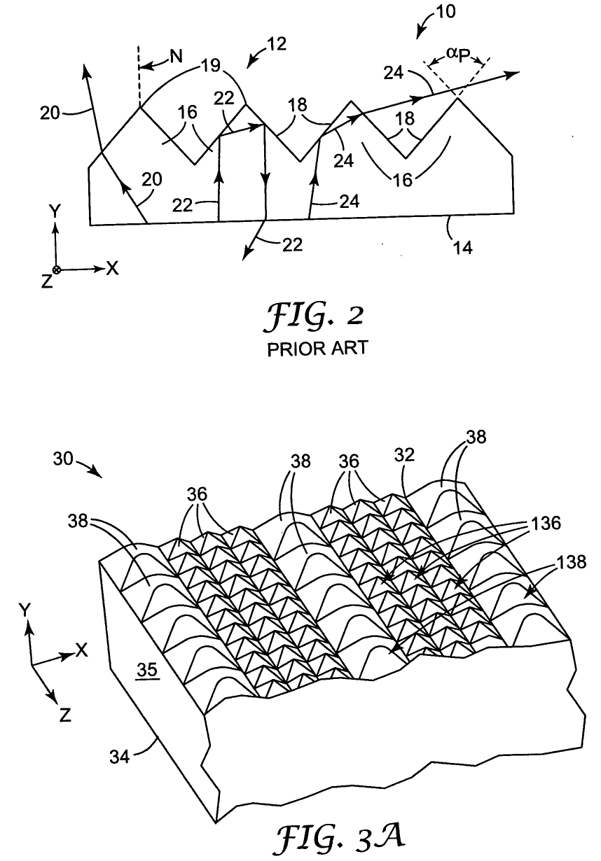

FIG. 2 generally illustrates the concept of structured optical films. In particular, FIG. 2 shows a schematic cross-sectional view of a regular, periodic structured optical film 10 including structured surface 12 and planar surface 14. Structured surface 12 includes a series of regularly spaced linear prisms 16 defined by facets 18, which form peaks 19. Prisms 16 have an included angle α_{P} (that is, the angle formed by facets 18). Typically, α_{P} is 90°, which allows for high optical gain. Each prism 16 extends substantially uninterrupted across the structured surface along the length of its peak 19 (i.e., along the Z-axis).

Light rays 20, 22, and 24 are shown in FIG. 2 to depict the behavior of light propagating in the optical film 10 at different angles with respect to the film normal N. Light rays 20 and 22 are shown in FIG. 2 to depict the desired operation of a structured optical film. Light ray 20, which is shown after entering the optical film 10 via refraction through the planar surface 14, depicts the situation in which a light ray contacts a facet 18 of the prism 16 below the critical angle required for total internal reflection (TIR). Light ray 20 is refracted through the facet within the preferred range of angles relative to film normal N.

Light ray 22, which also is shown after entering the optical film 10 via refraction through planar surface 14, depicts the situation in which a light ray strikes the two facets 18 of a prism 16 above the critical angle required for TIR of the light ray to occur. As a result, light ray 22, which would have exited the structured optical film 10 outside of the preferred range of angles, is reflected back toward the backlight assembly where a portion of it can be “recycled” and returned back to the structured film at an angle that allows it to escape from structured optical film 10.

With conventional structured optical film designs, some light escapes from prisms 16 at high glancing angles. This situation is illustrated schematically by the trajectory of light ray 24. Such light escapes when light ray 24 is reflected by TIR from a first facet to a second facet of a prism 16 such that light ray 24 contacts the second facet below the critical angle required for TIR of light ray 24 by the second facet. The second facet consequently refracts light ray 24, which escapes structured optical film 10 outside of the preferred range of angles. These high angle light rays may reduce the contrast of the display and produce undesirable areas of brightness outside of the preferred viewing angles or angle ranges of the display (e.g., within 30° of optical film normal N).

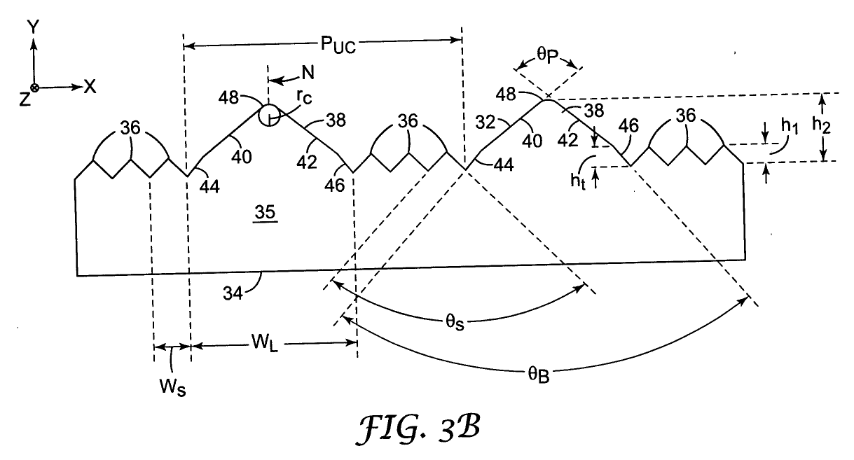

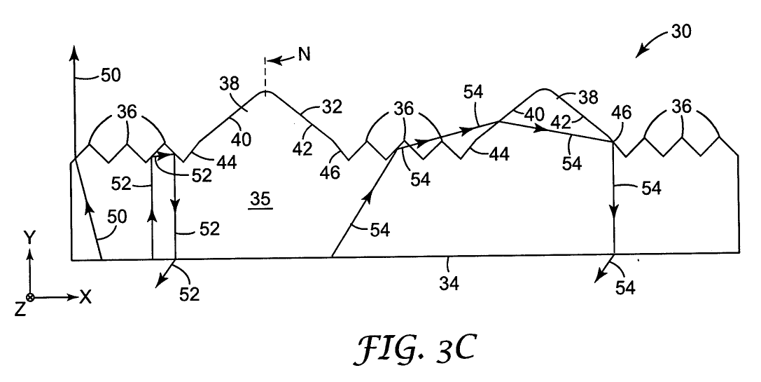

The present disclosure, described further in connection with the illustrative embodiment depicted in FIG. 3A and the following figures, provides a structured optical film wherein these high angle (e.g., angles greater than 60°) light rays are recaptured and redirected back toward the backlight assembly where a portion can be “recycled” and returned back to the structured optical film at an angle that allows it to escape from the film at a more desirable angle. This can improve contrast and increase brightness of the display at preferred viewing angles or angle ranges. In addition, the present disclosure provides a structured optical film that allows for the viewing angle ranges to be different along at least two different directions. Furthermore, the present disclosure provides a structured optical film that exhibits optical gain, which, for the purposes of the present disclosure, is defined as the ratio of the axial output luminance of an optical system with an optical film constructed and arranged according to the present disclosure to the axial output luminance of the same optical system without such optical film.

FIG. 3A is a perspective view and FIGS. 3B and 3C are partial cross-sectional views of an exemplary structured optical film 30 according to an embodiment of the present disclosure. Structured optical film 30 includes a structured surface 32 and a first surface 34, which may be a planar surface. The structured surface 32 is formed on and the first surface 34 is defined by a substrate portion 35. Structured surface 32 includes a plurality of smaller pyramidal structures 36 and a plurality of larger pyramidal structures 38 arranged in a two-dimensional array. In some exemplary embodiments, the two-dimensional array of the larger and smaller pyramidal structures may form a periodic pattern, e.g., a particular sequence of pyramidal structures may be arranged in a repeating sequence along the X direction, Z direction or both.

In some exemplary embodiments, the structured surface 34 may include smaller pyramidal structures 36 arranged into first rows 136 and larger pyramidal structures 38 arranged into second rows 138, such that the first rows are interspersed with the second rows. As illustrated in FIG. 3A, at least two first rows 136 may be disposed between each two of the second rows 138. However, other suitable configurations of the structured surface 34 are within the scope of the present disclosure, e.g., in which one first row 136 is disposed between second rows 138. Generally, the geometry of the structured surface 32 and the material(s) used to manufacture the optical film 30 may be selected to reduce the escape of light through the structured surface outside of a desired range or ranges of angles relative to film normal N.

The pyramidal structures 36 and 38 of the optical film 30 may be used to control the direction of light transmitted through the optical film 30, and, particularly, the angular spread of output light along two different directions, as further explained below. The pyramidal structures 36 and 38 can be closely packed, e.g., arranged on the surface 32 side-by-side and in close proximity to one another, and, in some exemplary embodiments, in substantial contact or immediately adjacent to one another. In other exemplary embodiments, the pyramidal structures may be spaced from each other provided that the gain of the optical film 30 is at least about 1.1. For example, the pyramidal structures may be spaced apart to the extent that the structures occupy at least about 50% of a given useful area of the structured surface 32, or, in other exemplary embodiments, the pyramidal structures may be spaced further apart to the extent that the structures occupy no less than about 20% of a given useful area of the structured surface 32. The pyramidal structures 36 and/or 38 may be two-dimensionally aligned with each other, offset with respect to one another (angularly, transversely or both) or arranged in a random distribution. Suitable offset arrangements of pyramidal structures are described in the commonly owned U.S. application Ser. No. 11/026,938, by Ko et al., filed on Dec. 30, 2004, the disclosure of which is hereby incorporated by reference herein to the extent it is not inconsistent with the present disclosure. In typical embodiments of the present disclosure, the size, shape and spacing of (or a given useful area covered by) the pyramidal structures are selected to provide an optical gain of at least about 1.1.

FIG. 3B is a partial cross-sectional view of an exemplary structured optical film 30 according to the present disclosure, showing its various parameters. Pyramidal structures 36 have a first height h₁ and pyramidal structures 38 have a second height h₂ greater than first height h₁ (h₂>h₁). Preferably, h₁ and h₂ are chosen such that a light ray escaping from the peak of a prism 36 at an angle of about 75° from the normal N to the film will be intercepted by one of the pyramidal structures 38. It is expected that h₂ would generally be at least one and a half times as great as h₁ although smaller or larger ratios may work depending on the design of the structured surface 32 and other factors. In some exemplary embodiments h₂ is at least twice as great as h₁ and in other exemplary embodiments h₂ is at least three times as great as h₁. In some embodiments, the first height h₁ may be in the range of about 5 μm to about 20 μm, and the second height h₂ may be in the range of about 20 μm to about 50 μm. Nonetheless, the absolute and relative heights of the pyramidal structures will depend on a particular application. However, typically pyramidal structures 36 should be at least large enough that diffractive effects do not introduce undesirable color and pyramidal structures 38 should not be large enough to be visible to a user of the optical device with which the film is used.

Each pyramidal structure 36, 38 includes two opposing pairs of facets, each pair of facets defining an included angle, a peak and a base. Opposing facets of the pyramidal structures 36 define included angles θ_{S}. The peak of pyramidal structures 38 can be defined by a pair of opposing peak facets 40 and 42, which have an included angle θ_{P}. Two opposing sides of bases of pyramidal structures 38 can be defined by a pair of opposing base facets 44 and 46, which have an included angle of θ_{B}. In such exemplary embodiments, included angles θ_{S} and θ_{B} are preferably both about 90° and the included angle θ_{P} is preferably in the range of about 70° to about 110°. In other exemplary embodiments, the pyramidal structures 38 have only one pair of opposing facets disposed opposite to each other along a particular direction. In the exemplary embodiments having a pair of opposing peak facets 40 and 42 as well as a pair of opposing base facets 44 and 46, pyramidal structures of only one type may be used on the structured surface, e.g., larger pyramidal structures 38 without the smaller pyramidal structures 36 and vice versa. Generally, any included angles may be in the range of about 70° to about 110°, or sometimes even in the range of about 30° to about 120°. In some exemplary embodiments, one or more of the included angles can be about 90° to increase gain. The included angles of each of the pyramidal structures 36 and/or 38 in the XY and ZY planes may be the same or different.

In the exemplary embodiment illustrated in FIG. 3B, pyramidal structures 38 have a truncation height ht, which is the height at which the base facets 44 and 46 meet peak facets 40 and 42. In some exemplary embodiments, truncation height ht and height h₁ of pyramidal structures 36 are substantially similar. Furthermore, pyramidal structures 38 have base widths w_{L} and pyramidal structures 36 have base widths w_{S}, which may be the same or different along different direction, e.g., X and Z directions. As shown in FIG. 3B, width w_{L} along the X direction is larger than width w_{S} along the same direction (w_{L}>w_{S}). For example, width w_{S} may be less than 30% of width w_{L}. In some embodiments, the base widths are in the range of about 5 to about 300 microns or about 10 to about 100 microns. Width w_{S} may be in the range of about 10 μm to about 40 μm, and width w_{L} may be in the range of about 40 μm to about 100 μm. Unit cell pitch P_{UC} can be used to describe the width of a repeating unit of pyramidal structures (i.e., a unit cell) in some exemplary optical films 30. In the embodiment shown in FIG. 3B, a unit cell includes three pyramidal structures 36 and one pyramidal structure 38.

Peak facets 40 and 42 of pyramidal structures 38 meet to form peak tip 48. Peak tip 48 is shown in FIGS. 3A-3C having a rounded or blunted contour. The rounded contour can be characterized by a radius of curvature r_{C}. The pyramidal structures can have radii of curvature that are the same or different in different planes, e.g., YX and YZ planes. The one or more radii are preferably no more than about 20% of the corresponding base widths, but in other exemplary embodiments the radii may be up to about 40% of the corresponding base widths or more, depending on the acceptable value of the optical gain. In some exemplary embodiments, radius of curvature r_{C} in the YX plane is about 12 μm or less, about 10.5 μm or less, or about 6 μm or less. Alternatively or additionally, the valleys disposed between the bases of the pyramidal structures may be rounded.

While rounding peak tips 48 results in a decrease of optical gain of the structured optical film, rounding the peaks of the pyramidal structures may have one or more of the following advantages: the viewing angle cutoff is softened by the curvature, which may make it less apparent to a viewer of the display device; the curved peaks make the film less likely to be damaged during handling than a similar film with sharp peaks; rounded peaks, in certain cases, reduce the amount of light emitted from the structures at glancing angles (70 to 90 degrees from normal), so that rounded peaks in certain cases may improve contrast when compared to sharp peaks. Because pyramidal structures 38 are taller than pyramidal structures 36, the peaks of pyramidal structures 36 are protected from damage during handling and use, which allows pyramidal structures 36 to have sharp peaks to improve gain. Alternatively, for some applications, pyramidal structures 38 may have sharp peak tips 48 (i.e., radius of curvature r_{C} of zero) to maximize gain of the pyramidal structures 38. Rounding the valleys of the pyramidal structures also may soften the viewing angle cutoff, which may make it less apparent to a viewer of the display device.

FIG. 3C is a partial cross-sectional view of structured optical film 30, showing the behavior of light rays propagating in the structured optical film at different angles. As mentioned above, optical film 30 can be incorporated into an optical system or device including a backlight (see FIGS. 1A-1D) providing light to optical film 30. Light rays 50, 52, and 54 are shown in FIG. 3C to depict the behavior of light supplied to the optical film 30 by a backlight.

Light ray 50, which is shown after entering optical film 30 via refraction through the first surface 34, depicts the situation in which a light ray reaches a pyramidal structure 36 below the critical angle required for TIR. Light ray 50 is refracted through the facet within the preferred range of angles relative to film normal N.

Light ray 52, which also is shown after entering optical film 30 via refraction through the first surface 34, depicts the situation in which a light ray reaches a pyramidal structure 36 above the critical angle required for TIR. As a result, light ray 52, which would have exited structured optical film 30 outside of the preferred range of angles, is reflected back toward the backlight assembly where a portion of it can be “recycled” and returned back to the structured film at an angle that allows it to escape from structured optical film 30.

Light ray 54 is shown after entering structured optical film 30 via refraction through the first surface 34 and depicts the situation in which a light ray is allowed to escape from pyramidal structures 36 at high glancing angles. This is the undesirable situation described with regard to light ray 24 of FIG. 2. In this case, light ray 54 is reflected by TIR from a first facet to a second facet of a pyramidal structure 36 and contacts the second facet below the critical angle required for TIR. The second facet then refracts light ray 54, which escapes structured optical film 30 outside of the desired range of angles.

In the structured optical film 30 according to the present invention, high angle light rays may be reduced, for example, as follows. First, high angle light rays transmitted by pyramidal structures 36 (e.g., light ray 54) are recaptured by pyramidal structures 38. Second, pyramidal structures 38 may have included angles θ_{P} and θ_{B} such that light rays that reach pyramidal structures 38 directly from the backlight assembly at undesirable angles are more likely to be reflected via TIR back toward the backlight assembly, rather than being transmitted from optical film 30 at a high glancing angle. In both cases, upon reaching the backlight assembly a portion of the light is “recycled” and returned back to structured film 30 at an angle that allows it to escape from structured optical film 30 at a more desirable angle. In order to facilitate the recapture and recycling of light distributed by pyramidal structures 36 in high angle lobes, angle θₚ formed by facets 40 and 42 is usually in the range of about 70° to about 110°, and preferably in the range of about 90° to about 110° (with an angle of about 96° more preferred). Facets 40 and 42 positioned at these preferred angles with respect to each other produce a greater likelihood of recapture of high angle light rays.

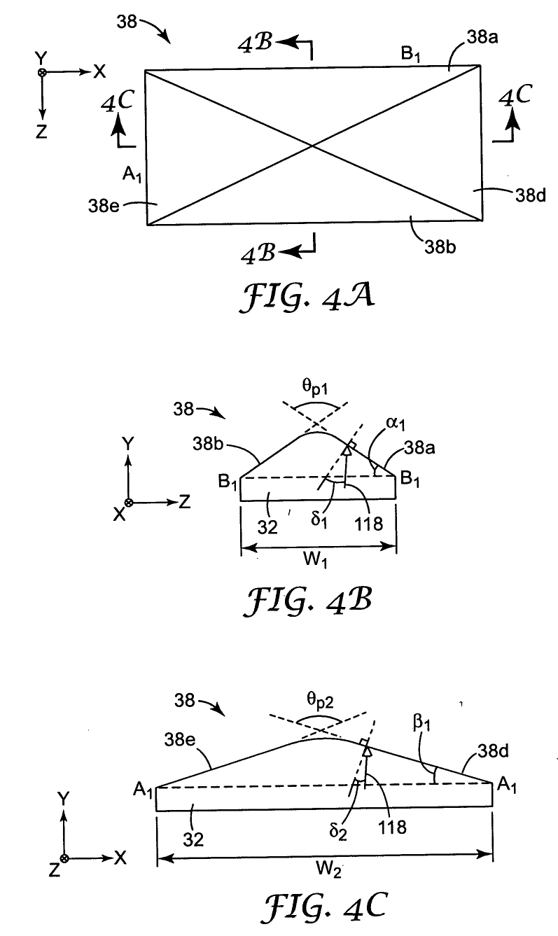

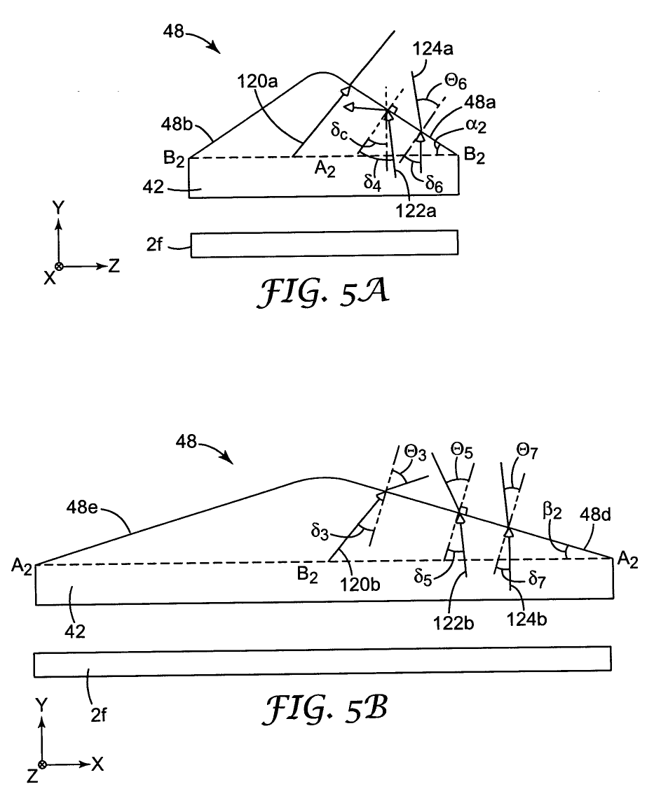

FIGS. 4A-4C and 5A-5B illustrate further aspects of structured optical films constructed according to the present disclosure. An exemplary individual pyramidal structure 38 is shown in FIGS. 4A-4C, but the following discussion also applies to the pyramidal structures 36. FIG. 4A shows a top view of the structure 38. The base of the pyramidal structure 38 is a four-sided shape with a first base width w₁ shown in FIG. 4B and a second base width w₂ shown in FIG. 4C. The base includes two first sides A₁, disposed generally opposite to each other along a direction shown as 4C, and two second sides B₁, disposed generally opposite to each other along a direction shown as 4B. In the exemplary embodiment shown in FIGS. 4A-4C, the length of w₁ is less than the length of w₂, the two first sides A₁ are substantially parallel to each other, and the two second sides B₁ are substantially parallel to each other. Furthermore, in this exemplary embodiment, the first sides A₁ are substantially perpendicular to the second sides B₁. Thus, the base of the pyramidal structure 38 of this exemplary embodiment is substantially rectangular. However, in other exemplary embodiments any of these parameters may have different relationships. For example, the first sides A₁ can have the same length as the second sides B₁ and the sides may be disposed at different angles with respect to each other.

FIG. 4B shows a cross-sectional view of the pyramidal structure 38 in the 4B-4B plane as shown in FIG. 4A. The pyramidal structure 38 includes two facets 38a and 38b. The facets 38a and 38b define an included peak angle θₚ₁. One or both of the facets 38a, 38b also define an angle α₁ measured between one of the facets 38a, 38b and a plane parallel to a substrate portion 32. FIG. 4C shows a cross-sectional view of the pyramidal structure 38 in the 4C-4C plane as shown in FIG. 4A. The pyramidal structure 38 includes two facets 38d and 38e. The facets 38d and 38e define an included peak angle θₚ₂. One or both of the facets 38d, 38e also define an angle β₁ measured between one of the facets 38d, 38e and a plane parallel to the substrate portion 32. The angle α₁ can be as great as the angle β₁, smaller or larger.

FIGS. 4B and 4C show a light ray 118 traveling within the pyramidal structure 38. The surface 38a and the surface 38d may reflect or refract the light ray 118 depending on an incident angle δ₁ or δ₂ of the light ray 118 with respect to a normal to the surface 38a or the surface 38d. As one of ordinary skill in the art will understand from the present disclosure, selecting different angles α₁ and β₁ allows one to control the angular spread of light transmitted through the pyramidal structures of an optical film (e.g., optical film 30). In some exemplary embodiments, the angles between the opposing pairs of surfaces and a plane parallel to a substrate portion are not equal to each other, which may be advantageous where a viewing axis that is tilted with respect to a normal to the substrate portion is desired.

FIG. 5A shows a cross-sectional view of an individual exemplary pyramidal structure 48 of an optical film according to the present disclosure. A light ray 120a, a light ray 122a, and a light ray 124a, emitted from a backlight 2f, propagate in the pyramidal structure 48. FIG. 5B shows another cross-sectional view of the exemplary embodiment of the pyramidal structure 48. A light ray 120b, a light ray 122b, and a light ray 124b, which have the same directions as light rays 120a, 122a, and 124a respectively, shown in FIG. 5A, originate from the backlight 2f and propagate in the pyramidal structure 48.

FIGS. 5A and 5B show how a light ray may behave differently depending on whether it first impacts the surface 48a or the surface 48d, and how the angular spread of light may be controlled in two separate directions by selecting an angle α₂ of a surface 48a and/or an angle β₂ of a surface 48d. In FIG. 5A, the light ray 120a originating from a backlight 2f travels in the pyramidal structure 48 in a direction perpendicular to the surface 48a. Thus, the light ray 120a encounters and is transmitted through the surface 48a at an angle of about zero degrees relative to the normal of the surface 48a. FIG. 5B shows the light ray 120b traveling in substantially the same direction as the light ray 120a. Because the angle β₂ of the surface 48d is less than the angle α₂ of the surface 48a, the light ray 120b encounters the surface 48d at a non-zero incident angle δ₃ relative to a normal to the surface 48d. The light ray 120b is thus refracted at an exit angle θ₃.

As shown in FIG. 5A, the light ray 122a travels into the structure 48 and encounters the surface 48a at the incident angle δ₄ relative to the normal to the surface 48a. Because the incident angle δ₄ for the light ray 122a is greater than the critical angle δ_{c} at the surface 48a, the light ray 122a experiences TIR. As shown in FIG. 5B, the light ray 122b, traveling in substantially the same direction as the light ray 122a, encounters the surface 48d. Because the angle β2 of the surface 48d is less than the angle α₂ of the surface 48a, the light ray 122b encounters the surface 48d at an angle that is less than the critical angle δ_{c} and, therefore, the light ray 122b is refracted at the surface 48d.

The light ray 124a and the light ray 124b, shown in FIGS. 5A and 5B respectively, travel in the pyramidal structure 48 in a direction perpendicular to the substrate portion 42. The light rays 124a and 124b encounter the surface 48a and the surface 48d, respectively, at incident angles δ less than the critical angle δ_{c}. However, the incident angle δ₆ of the light ray 124a relative to the normal of the surface 48a is greater than the incident angle δ₇ of the light ray 124b relative to the normal of the surface 48d. Hence, according to Snell's Law, the exit angle θ₆ of the light ray 124a relative to the normal of the surface 48a will be greater than the exit angle θ₇ of the light ray relative to the normal to the surface 48d.

As one of ordinary skill in the art would understand, the surface 48d with the greater angle α₂ may generally “focus” more light toward a direction perpendicular to the backlight 2f than the surface 48a with the lesser angle β₂. Thus, an optical film with pyramidal structures 48 as described above may allow a greater angular spread of light along one direction and a lesser angular spread of light along another direction. For example, an exemplary optical film of the present disclosure may be employed in an LCD television to provide a wider angular spread of light in a first direction, e.g., the horizontal direction, and a lesser but still substantial angular spread of light in a second direction, e.g., the vertical direction. This may be advantageous to accommodate the normally wider field of view in the horizontal direction (e.g., viewers on either side of the television) than in the vertical direction (e.g., viewers standing or sitting). In some exemplary embodiments, the viewing axis may be tilted downward, such as where a viewer may be sitting on the floor. By reducing the angular spread of light in the vertical direction, an optical gain may be experienced in a desired viewing angle range.

The periodic pattern of pyramidal structures as shown in FIGS. 3A-3C is merely exemplary, and other patterns may be used where, generally, larger pyramidal structures 38 are interspersed with smaller pyramidal structures 36. For example, fewer or more pyramidal structures 36 may be positioned between pyramidal structures 38. While fewer high angle rays are captured with the additional space (i.e., additional pyramidal structures 36) between pyramidal structures 38, additional pyramidal structures 36 allow for an increase in gain, since pyramidal structures 36 can be shaped to increase gain.

Furthermore it is not necessary that all of pyramidal structures 38 be the same height or that all of pyramidal structures 36 be the same height. For various reasons these heights may be varied. It should also be noted that various individual parameters of pyramidal structures 36 and 38 may be adjusted without departing from the spirit and scope of the present invention. For example, first height h₁ of pyramidal structures 36 and second height h₂ of pyramidal structures 38 may be adjusted as system requirements and specifications dictate to adjust gain and recapture of high angle rays or due to other considerations. In addition, pyramidal structures of intermediate heights may be included in structured optical films of some exemplary embodiments. Furthermore, pyramidal structures 36 and 38 are shown in FIGS. 3A-3C and 3 with generally planar facets, but it will be understood that the present invention includes structured optical films having pyramidal structures and facets formed in any optically useful shape, such as rounded valleys, curved facets, etc.

Although the particular material used to manufacture structured optical films according to the present invention may vary, it is important that the material be substantially transparent to ensure high optical transmission. Useful polymeric materials for this purpose include substantially transparent curable materials and commercially available materials such as, for example, acrylics, polycarbonates, acrylate, polyester, polypropylene, polystyrene, polyvinyl chloride, and the like. While the particular material is not critical, materials having higher indices of refraction will generally be preferred. More specifically, materials having indices of refraction greater than 1.5 are most preferable for some applications. With high refractive index materials, higher optical gain may be achieved at the expense of a narrower viewing angle, while with lower refractive index materials, wider viewing angles may be achieved at the expense of lower optical gain. Exemplary suitable high refractive index resins include ionizing radiation curable resins, such as those disclosed in U.S. Pat. Nos. 5,254,390 and 4,576,850, the disclosures of which are incorporated herein by reference to the extent they are consistent with the present disclosure. Other useful materials for forming structured optical films are discussed in U.S. Pat. No. 5,175,030 (Lu et al.) and U.S. Pat. No. 5,183,597 (Lu).

A structured surface film according to the present invention may be manufactured by any suitable processes, including but not limited to embossing, molding (such as compression molding or injection molding), extrusion, laser ablation, photo-lithography, batch processes and cast and cure processes. The optical film according to the present disclosure may be formed of or include any suitable material known to those of ordinary skill in the art including, for example, inorganic materials such as silica-based polymers, and organic materials, such as polymeric materials, including monomers, copolymers, grafted polymers, and mixtures or blends thereof.

As one of ordinary skill in the art would understand, the pyramidal structures and the substrate portion may be formed as a single part, and in some cases from the same material, to produce the structured optical film, or they may be formed separately and then joined together to produce a single part, for example, using a suitable adhesive. In some exemplary embodiments, the pyramidal structures may be formed on the substrate portion.

The substrate portion can have an additional optical characteristic that is different from the optical characteristics of the structured surface, that is, the substrate portion would manipulate light in a way that is different from the way light would be manipulated by the structured surface. Such manipulation may include polarization selectivity, diffusion or additional redirection of light transmitted through the optical films of the present disclosure. This may be accomplished, for example, by including in the substrate portion an optical film having such an additional optical characteristic or constructing the substrate portion itself to exhibit such an additional optical characteristic. Exemplary suitable films having such additional optical characteristics include, but are not limited to, a polarizer film, a diffuser film, a brightness enhancing film such as BEF, a turning film and any combination thereof.

Turning film may be, for example, a reversed prism film (e.g., inverted BEF) or another structure that redirects light in a manner generally similar to that of a reversed prism film. In some exemplary embodiments, the substrate portion may include a cholesteric reflective polarizer or a linear reflective polarizer, such as a multilayer reflective polarizer, e.g., Vikuiti™ Dual Brightness Enhancement Film (“DBEF”) or a diffuse reflective polarizer having a continuous phase and a disperse phase, such as Vikuiti™ Diffuse Reflective Polarizer Film (“DRPF”), both available from 3M Company.

In some exemplary embodiments, the substrate portion can have an additional mechanical property. For example, a relatively rigid sheet of plastic or glass could be laminated to the film in order to provide better resistance to warp. Additionally or alternatively, the substrate portion may include a polycarbonate layer (“PC”), a poly methyl methacrylate layer (“PMMA”), a polyethylene terephthalate (“PET”) or any other suitable film or material known to those of ordinary skill in the art. Exemplary suitable substrate portion thicknesses include about 125 μm for PET and about 130 μm for PC.

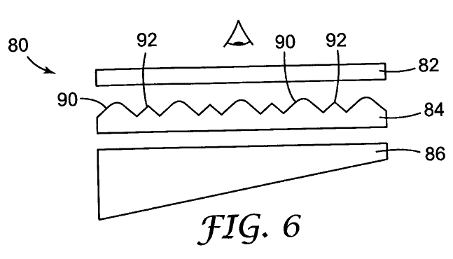

FIG. 6 illustrates one application in which a structured optical film according to the present invention can be advantageously used. The application is a backlit optical display assembly 80. Optical display assembly 80 includes a display panel 82 and structured optical film 84 according to the present invention. The larger pyramidal structures 90 of the structured optical film 84 redirect light distributed by smaller pyramidal structures 92 in high angle lobes back toward backlight assembly 86. Structured optical film 84 is a conceptual representation of any of the embodiments of the present invention (or variations thereof) heretofore described with regard to FIGS. 3A-3C and 4A-4B. Structured optical film 84 is preferably positioned between display panel 82 and backlight assembly 86 with the structured surface facing display panel 82 and the planar surface facing backlight assembly 86.

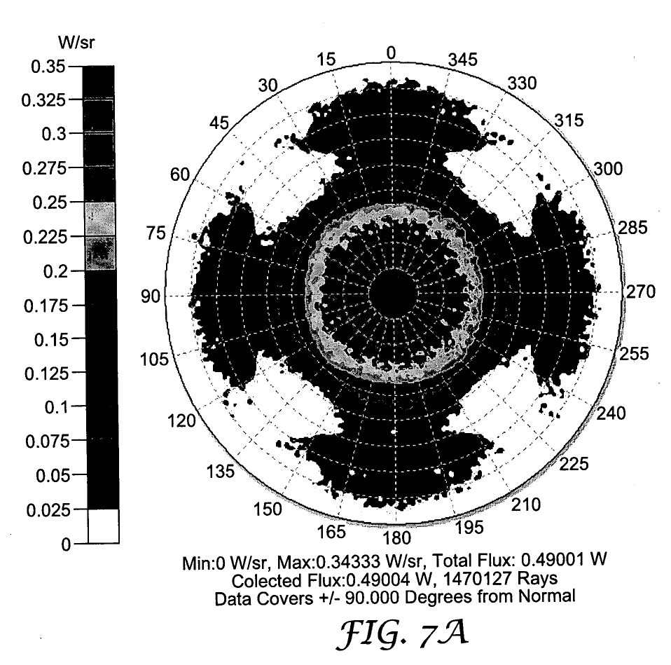

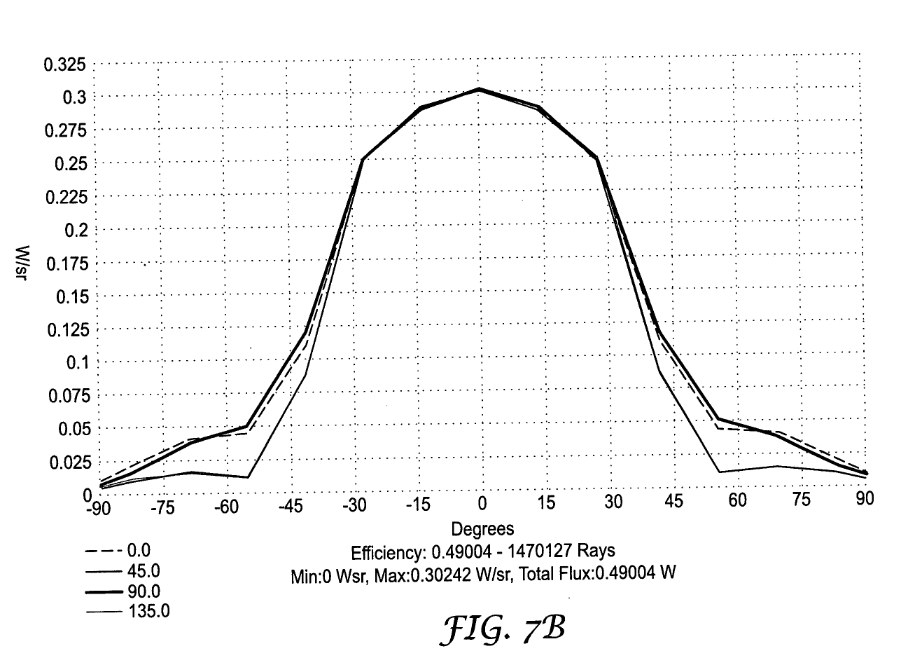

FIG. 7A represents a calculated polar iso-candela distribution plot for light exiting an optical film having the structure substantially as shown in FIG. 3A with two rows of smaller pyramidal structures interspersed with single rows of larger pyramidal structures, placed over a backlight with the structured surface facing away from the light source. In this exemplary embodiment, the pyramidal structures were immediately adjacent to each other and had a refractive index of about 1.58. A base of each of the pyramidal structures 36 and 38 was modeled as a four-sided shape with two first sides A₆, disposed generally opposite to each other along a direction Y, and two second sides B₆, disposed generally opposite to each other along a direction X. Each smaller pyramidal structure 36 of this exemplary embodiment had a 50×60 microns rectangular base and a sharp tip, and each larger pyramidal structure 38 of this exemplary embodiment had a 100×120 microns rectangular base and a rounded tip with the radius of curvature of 12 microns. The peak angles were all set to about 90 degrees. The substrate portion was modeled as a substantially planar film with a refractive index of about 1.66.

The distribution was calculated using the following model: an extended Lambertian source was used on the first pass of light through the optical film and the remaining light was recycled using a Lambertian reflector with a reflectivity of about 77.4%. As one of ordinary skill in the art will understand, the iso-candela distribution plots show a three hundred and sixty degree pattern of detected incident light rays having passed through the optical film. As it is apparent from FIG. 7A, side lobes along the X direction of the optical film 30 are reduced as compared to the side lobes along the Z direction. Furthermore, FIG. 7A shows a distribution with a relatively high degree of radial symmetry, which may be desirable for some applications.

Similar conclusions can be drawn from FIG. 7B, which shows rectangular candela distribution plots. As one of ordinary skill in the art will understand, each curve on the rectangular distribution plots corresponds to a different cross-section of the polar plot. For example, the curve designated as 0 degrees represents the cross-section of the polar plot along the line passing through the center that connects 0 and 180 degrees, the curve designated as 45 degrees represents the cross-section of the polar plots along the line passing through the center that connects 45 and 225 degrees, the curve designated as 90 degrees represents the cross-section of the polar plots along the line passing through the center that connects 90 and 270 degrees, and the curve designated as 135 degrees represents the cross-section of the polar plots along the line passing through the center that connects 135 and 315 degrees. Modeled optical gain for the exemplary optical films constructed according to FIG. 6A was found to be about 1.57. FIG. 7B also shows that high angle output is reduced along one direction of the optical film and that the transition from bright to dark is smoother along that direction as well. Furthermore, the figure illustrates that these characteristics may be controlled independently along two different directions.

Thus, the present disclosure provides optical films that can cause a particular type of angular spread of output light, which may be different along two different directions, and also exhibit optical gain. The amounts of gain and the amount and type of angular spread will depend on the specific configuration of the surface structures and may be varied to achieve the performance desired for a particular application. The present disclosure also provides structured optical films that allow for recycling high angle light rays back to the structured film for retransmission within the desired range of angles.

Although the optical films and devices of the present disclosure have been described with reference to specific exemplary embodiments, those of ordinary skill in the art will readily appreciate that changes and modifications may be made thereto without departing from the spirit and scope of the present disclosure.

What is claimed is:

1. An optical film, comprising:
a substantially transparent body having a first surface defined by a substrate portion and a structured surface disposed over the substrate portion opposite to the first surface and comprising a plurality of smaller pyramidal structures and a plurality of larger pyramidal structures interspersed with the plurality of smaller pyramidal structures, each pyramidal structure having a base including at least two first sides disposed opposite to each other and at least two second sides disposed opposite to each other.

2. The optical film according to claim 1, wherein the plurality of smaller pyramidal structures are arranged into a plurality of first rows and the plurality of larger pyramidal structures are arranged into a plurality of second rows, and wherein the first rows are interspersed with the second rows.

3. The optical film according to claim 2, wherein at least two first rows are disposed between each two of the second rows.

4. The optical film according to claim 1, wherein each larger pyramidal structure has a peak defined by a first pair of facets and the first sides of the base are defined by a second pair of facets and wherein the first pair of facets has a first included angle and the second pair of facets has a second included angle, the first included angle being different than the second included angle.

5. The optical film according to claim 1, wherein the substrate portion has an additional optical characteristic different from an optical characteristic of the structured surface.

6. The optical film according to claim 1, wherein the substrate portion comprises at least one of: a polarizer, a diffuser, a brightness enhancing film, and a turning film.

7. The optical film according to claim 1, wherein the bases of larger pyramidal structures have a generally square shape.

8. The optical film according to claim 1, wherein each of the pluralities of pyramidal structures are further characterized by a peak angle that lies within a range of about 30 degrees to about 120 degrees.

9. The optical film according to claim 1, wherein each larger pyramidal structure has a rounded peak.

10. The optical film of claim 1, wherein the first and second sides of different pyramidal structures are substantially parallel to each other.

11. An optical device comprising a light source and the optical film of claim 1 disposed so that the structured surface faces away from the light source.

12. The optical device according to claim 11, further comprising a light gating device disposed to receive light transmitted through the optical film.

13. An optical film, comprising:
a substantially transparent body having a first surface defined by a substrate portion and a structured surface disposed over the substrate portion opposite to the first surface and comprising a plurality of smaller pyramidal structures and a plurality of larger pyramidal structures interspersed with the plurality of smaller pyramidal structures, each pyramidal structure having a base including at least two first sides disposed opposite to each other and at least two second sides disposed opposite to each other,
wherein in the plurality of the larger pyramidal structures, the first sides are longer than the second sides.

14. The optical film of claim 13, wherein in the plurality of the smaller pyramidal structures, the first sides are longer than the second sides.

15. The optical film of claim 13, wherein the first and second sides of different pyramidal structures are substantially parallel to each other.

16. The optical film according to claim 16, further including a substrate portion that comprises at least one of: a polarizer, a diffuser, a brightness enhancing film, and a turning film.

17. An optical device comprising a light source and the optical film of claim 13 disposed so that the structured surface faces away from the light source.

18. An optical film, comprising:
a substantially transparent body having a first surface defined by a substrate portion and a structured surface disposed over the substrate portion opposite to the first surface and comprising a plurality of pyramidal structures, each pyramidal structure having a peak and a base, the peak defined by a first pair of facets and the base including at least two first sides disposed opposite to each other defined by a second pair of facets and at least two second sides disposed opposite to each other,
wherein the first pair of prism facets has a first included angle and the second pair of prism facets has a second included angle, and wherein the first included angle is different than the second included angle.

19. The optical film of claim 18, wherein the first included angle is greater than 90° and the second included angle is about 90°.

20. The optical film of claim 18, wherein the peak is rounded.

21. The optical film according to claim 18, further including a substrate portion that comprises at least one of: a polarizer, a diffuser, a brightness enhancing film, and a turning film.

22. An optical device comprising a light source and the optical film of claim 18 disposed so that the structured surface faces away from the light source.
